(19) United States
(12) Patent Application Publication
(10) Pub. No.: US 2012/0198381 A1
(43) Pub. Date: Aug. 2, 2012

(54) GRAPHICAL USER INTERFACE PRESENTING A UNIFIED VIEW OF A MAIN DOCUMENT IMAGE AND THUMBNAIL IMAGES

(75) Inventor: Danny KUMAMOTO, Garden Grove, CA (US)

(73) Assignee: KONICA MINOLTA LABORATORY U.S.A., INC., San Mateo, CA (US)

(21) Appl. No.: 13/016,787

(22) Filed: Jan. 28, 2011

(51) Int. Cl. G06F 3/048

(52) U.S. Cl. 715/781

(57) ABSTRACT

A GUI for displaying a main document image and multiple thumbnail images in a more space-efficient manner. One unified pane displays both a page of the document as a main image and multiple thumbnail images each corresponding to a document page. At least some of the thumbnail images overlap with the main image, with the main image displayed either as a transparent image (transparent display mode) or a solid image (solid display mode) in front of the overlapped thumbnail images. When a user selects a thumbnail image, the corresponding document page is displayed in the main image. The use may switch between the two display modes. In the transparent display mode, overlapped thumbnail images are visible and selectable, and the main image is not editable. In the solid display mode, overlapped thumbnail images are not visible and not selectable, and the main image is editable.

This application is related to commonly owned U.S. patent application Ser. No. ______, filed ______ (attorney docket number 75675.B376), now pending, which is herein incorporated by reference in its entirety.

### BACKGROUND OF THE INVENTION

1. Field of the Invention

This invention relates to a graphical user interface, and in particular, it relates to a graphical user interface for presenting a main document image and multiple thumbnail images.

2. Description of Related Art

In many computer applications, one or more documents are displayed in a graphical user interface (GUI) in such a way that a plurality of pages of a document are displayed as thumbnail images and one or more selected pages of the document are displayed as the main document image. The thumbnail images corresponding to the selected pages are often highlighted. The main document image is substantially larger and has a higher resolution than the thumbnail images. For example, when the document contains text, the main document image typically displays the text in legible sizes, while the text in thumbnail images is often illegible. In addition, the applications typically allow the user to operate on the main document image (e.g., edit the content of the document), while the thumbnail images are typically displayed as non-editable images. The user can select a page of the document by clicking on a thumbnail image and have that page displayed as the main image.

In typical conventional GUIs with main document image and thumbnail images, an example of which is schematically illustrated in FIG. 1, the thumbnail images 11 are located in a thumbnail pane 12 (a pane is a portion of the window 10, often with its own navigation tools) and the main document image 13 is located in a main image pane 14, where the two panes are separate window areas each having a defined, albeit often adjustable, size. Often, all thumbnail images of the document cannot fit within the finite size of the thumbnail pane, and scroll bars are provided for the thumbnail pane to allow the user to scroll through the thumbnail images.

A GUI such as that shown in FIG. 1 provides the user with the ability to streamline the editing process. By using the thumbnail images as a visual reference, the user can quickly scroll through the thumbnail images of the entire document, locate a specific page among the thumbnails, open it in the main image pane, and then apply desired editing or other functions to that page.

### SUMMARY

The present invention provides an improved GUI for presenting both a main document image and a plurality of thumbnail images that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for displaying a document on a computer display device, which includes: (a) displaying a window having at least one pane; (b) displaying a plurality of pages of the document as a plurality of thumbnail images within the pane, each thumbnail image corresponding to a page of the document; (c) displaying a selected page of the document as a main image within the same pane, wherein the main image overlaps with at least some of the thumbnail images, wherein the main image is displayed either as a transparent image or as a solid image, wherein when the main image is displayed as the transparent image, the thumbnail images that overlap with the main image are displayed as visible thumbnail images through the transparent main image, and wherein when the main image is displayed at the solid image, the thumbnail images that overlap with the main image are invisible in overlapped portions, and (d) in response to a user's selection of one of the thumbnail images, displaying a new page of the document corresponding to the selected thumbnail image as the main image, wherein the newly displayed main image is displayed either as transparent image or as a solid image.

In another aspect, the present invention provides a computer program product comprising a computer usable non-transitory medium (e.g. memory or storage device) having a computer readable program code embedded therein for controlling a data processing apparatus, the computer readable program code being configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a conventional GUI window including a thumbnail pane and a main document image pane.

FIGS. 2(a) and 2(b) schematically illustrate a GUI window for displaying thumbnail images and a main document image in a unified pane according to an embodiment of the present invention.

FIG. 3 illustrates a computer system in which embodiments of the present invention may be implemented.

### DETAILED DESCRIPTION OF PREFERRED EMBODIMENTS

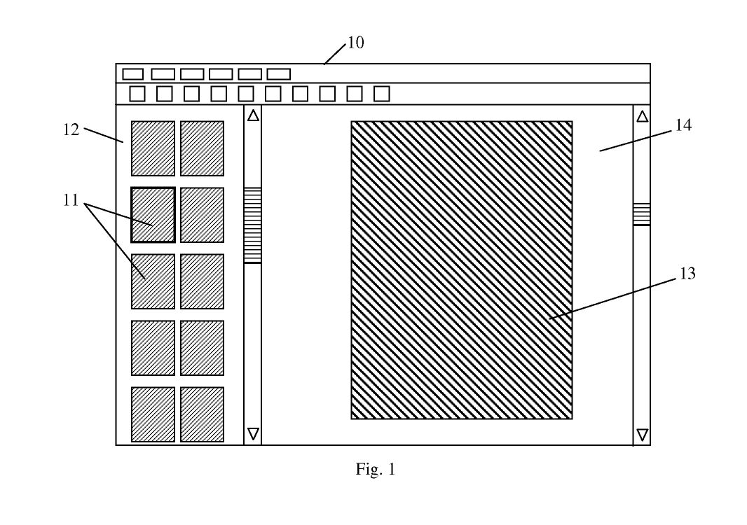

As pointed out earlier, a conventional GUI such as that shown in FIG. 1 requires two different panes to display the thumbnail images and the main document image. The thumbnail images are confined to the thumbnail pane, and the main document image is confined to the main image pane. This results in inefficient use of the screen real estate.

Embodiments of the present invention provide a layout of a GUI that displays both a main document image (one or more pages) and a plurality of thumbnail images in a more space-efficient manner. According to an embodiment of the present invention, one pane (e.g. a window not divided into multiple panes) displays both the plurality of thumbnail images and the main image. The thumbnail images and the main image are displayed in an overlapping fashion, with the main image displayed either as a transparent image or a solid image in front of the overlapped thumbnail images.

It should be noted here that the invention does not require the GUI window to have only one pane. In addition to the pane that displays the main document image and the thumbnail image, the window may have other panes for performing other functions. Also, while this disclosure refers to different areas of a window as panes, these areas can also be referred to as windows themselves. The term “pane” should be broadly understood to mean a defined area of the display screen where user content is displayed, and a pane may or may not have its own control tool such as menu items, buttons, and/or scroll bars.

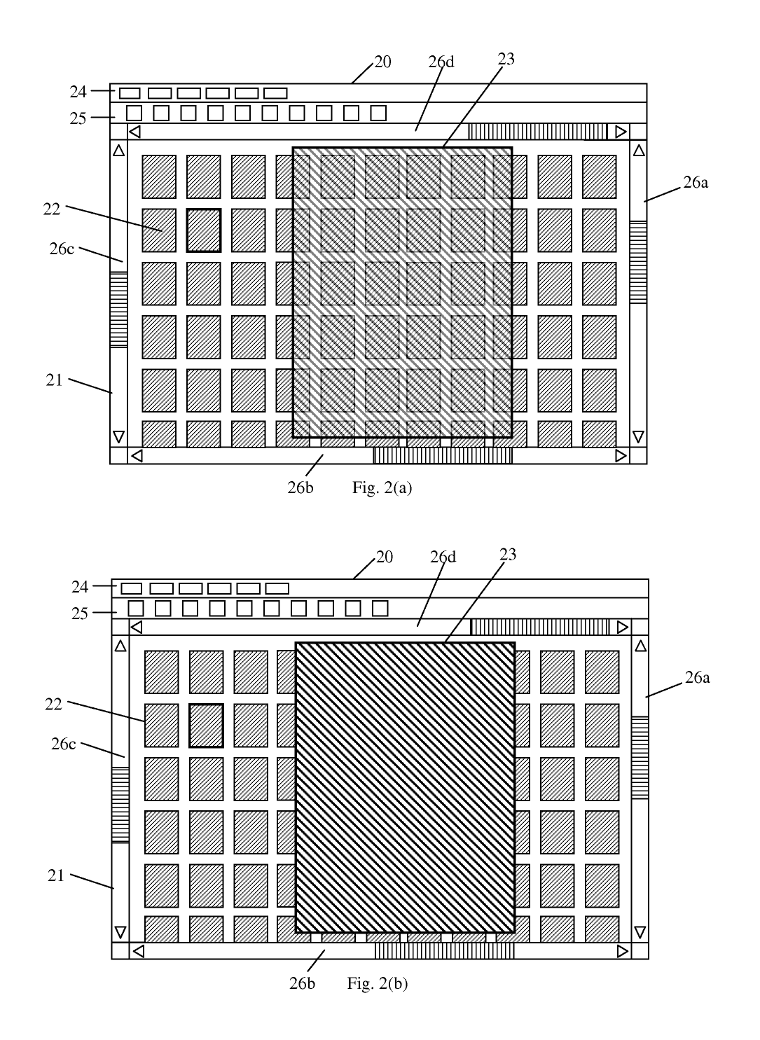

FIGS. 2(a) and 2(b) schematically illustrate a user interface display window for displaying thumbnail images and a main document image in a unified pane according to an embodiment of the present invention. As shown in FIGS. 2(a) and 2(b), the GUI window 20 has a pane 21 which displays both a plurality of pages of a document as thumbnail images 22 and a selected page of the document as the main image 23. The main image 23 is preferably located at or near a center of the pane 21 and is substantially larger in size than the thumbnail images 22. The thumbnail images 22 occupy substantially all of the areas of the pane 21, including the area occupied by the main image 23. In other words, the main image 23 overlaps or partially overlaps some of the thumbnail images 22. The main image 23 is displayed in front of the overlapped thumbnail images 22.

The main image 23 may be displayed either as a transparent image (referred to as the transparent display mode) or as a solid image (referred to as the solid display mode). The two display modes are selectable by the user. In the transparent display mode, schematically shown in FIG. 2(a), the main image 23 is displayed as transparent so that the overlapped thumbnail images 22 are visible through the main image. The user may select a thumbnail image 22, even if it is a completely overlapped or partially overlapped thumbnail image, by clicking on the thumbnail or other suitable action. In other words, in the transparent mode, all thumbnail images in the pane are selectable, including those that completely overlap the main image. When a thumbnail is selected, the corresponding page of the document is selected and displayed in the main image 23 (as a transparent image). In one implementation of the transparent display mode, the main image 23 is not editable, i.e., it does not allow the user to edit the selected page of document or perform other editing-related functions with respect to the selected page. In another implementation, the main image 23 is editable.

When the term “transparent” is used in this disclosure, it includes various degrees of transparency. From a functional standpoint, it means that two (or more) overlapping images can be simultaneously visible. This typically requires the pixels from both (or all) images be mixed or combined to generate the bitmap being displayed. Various degrees of transparency may be achieved by allowing different amounts of contribution from each image in the generated bitmap. It is often convenient to refer to one of the images as the foreground image, and when the foreground image is said to be (for example) “10% transparent”, it means that 10% of the bitmap is contribution from the other image(s), either in terms of pixel values or in terms of the number of pixels or both. Transparent images can be accomplished in various ways, both from a software standpoint and a hardware standpoint, which are generally known in the field of image display.

In the solid display mode, schematically shown in FIG. 2(b), the main document image 23 is displayed as solid (i.e. non-transparent) image so that the overlapped thumbnail images 22 are invisible through the main image. For partially overlapped thumbnail images, the portions that do not overlap with the main image will be visible, while the overlapped portions are invisible. The user may select a non-overlapped or partially overlapped thumbnail image 22 by clicking on it, and the corresponding page of the document will be selected and displayed in the main image 23 (as a solid image). The thumbnail images that completely overlap with (i.e. is completely hidden behind) the main image are un-selectable by the user. In the solid display mode, the main image 23 is editable, i.e., it allows the user to edit the selected page and/or perform other desired functions with respect to the selected page.

It should be noted that even when some thumbnail images are completely behind the main image and invisible in the solid display mode, they are still considered to be “displayed” in the context of the present embodiment. In particular, for example, the thumbnails may be spatially arranged in a sequential order in the pane, and this order is not changed regardless of whether the overlapped images are visible or not. In other words, the spatial arrangement of the visible thumbnails is not changed when switching between the transparent and solid display modes. Further, when the thumbnail images are scrolled, all displayed thumbnails including the non-visible ones move in synchrony, so that previously non-visible thumbnails can be moved out from behind the main image and become visible. Thus, the terms “displayed” or “displaying”, etc., when referring to thumbnails in the context of this embodiment, should be understood to includes situations where some thumbnails are not displayed in a strict technical sense, for example, they do not form a part of the bitmap imaged being displayed on the screen.

The GUI design shown in FIGS. 2(a) and 2(b) increases the useful workspace of the pane by allowing for overlap between the thumbnail images 22 and the main image 23. As mentioned above, the user can select one of the display modes. Thus, the user can select the transparent display mode to view and select a thumbnail image 22 even if it is overlapped by the main image, and then select the solid display mode to edit the selected page in the main image 23. The selection of the two modes may be achieved by using any suitable GUI control tools, such as a button, a drop-down menu, a popup menu, a click (such as a single click, a double click, etc.) with a predefined GUI area, etc. In one implementation, the solid display mode is the default display mode when the GUI starts up and the user can select the transparent display mode manually.

In both transparent display mode and the solid display mode, the pane 21 is preferably provided with tools to allow the user to scroll the thumbnail images, e.g., move all thumbnail images collectively left and right and/or up and down. As a result, thumbnail images 22 previous off of the pane area 21 may be moved into the pane area, and thumbnail images previous located behind the main image 23 may be moved out from behind the main image and become visible (in the solid display mode) or more visible (in the transparent display mode). This allows the user to select previously un-selectable thumbnail images. The main image is not moved in this process.

The main image 23 may be highlighted, for example, by a frame or a halo of color around the image. The one thumbnail image that corresponds to the selected page is preferably also highlighted, for example, by a frame or a halo of the same color as the main image. The highlight of this thumbnail image helps the user to see the location of the selected page within the document and its relation with other pages of the document.

The window 20 may be provided with various control tools such as a menu bar 24 containing various menu items, a button bar 25 containing various functional buttons, scroll bars including right, bottom, left and top scroll bars 26a-d, etc. These control tools can be used by the user to effectuate various desired functions of the GUI window. The functions and their implementation described below are merely exemplary; not all of them are required, and other functions may be provided. The functions may be implemented using control tools other than those described below. Those skilled in the programming art will be able to implement these functions without undue experimentation.

In one embodiment, the right and left scroll bars 26a and 26b are used to scroll the thumbnail images 22 in the pane 21 as described earlier. The left and top scroll bars 26c and 26d may be used to move the page content within the main image 23. In other words, if the main image 23 cannot display the content of the selected document page in its entirety, the content may be scrolled or moved within the main image so that the desired content can be visible. In addition, window tools may be provided to change the physical size of the main image 23 or the physical size of the thumbnail images 22, change the zoom size of the document content in the main image, etc.

In one embodiment, the menu items in the menu bar 24 and the buttons in the button bar 25 of the GUI window 20 perform functions applicable to the main image 23. For example, in a typical use case, the menu and buttons may implement various editing, formatting, and other functions for editing the content of the document page displayed in the main image 23.

Further, desired operations may be provided for the thumbnails, preferably whole page operations such as rotation of a page, cut and paste of a page, changing fonts of all the text in a given page, etc. In a preferred embodiment, these operations are implemented by a popup menu associated with a mouse click such as a right mouse click. The user may first select (e.g., by a mouse click) a target thumbnail image to be operated on. The user can also select multiple thumbnails (for example, using the CTRL plus mouse click operation or Apple-Key plus mouse click on MacOS) and perform batch operations on multiple pages.

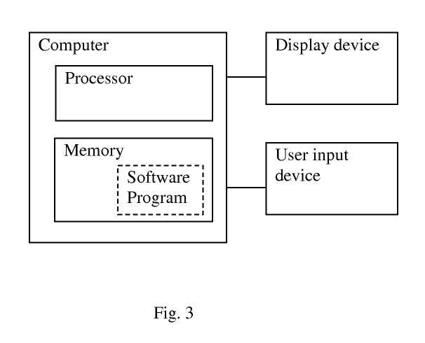

The user interface display methods described above can be implemented in a computer system which includes a processor and a memory storing a software program executed by the processor (see FIG. 3). The computer system also includes a display device for displaying the GUI window, as well as a user input device such as a keyboard and mouse for the user to input commands to the computer system. In one aspect, the invention is a method carried out by a computer system. In another aspect, the invention is computer program product embodied in computer usable non-transitory medium having a computer readable program code embedded therein for controlling a computer system.

It will be apparent to those skilled in the art that various modification and variations can be made in the user interface display and related method of the present invention without departing from the spirit or scope of the invention. Thus, it is intended that the present invention cover modifications and variations that come within the scope of the appended claims and their equivalents.

What is claimed is:

1. A method for displaying a document on a computer display device, comprising:
(a) displaying a window having at least one pane;
(b) displaying a plurality of pages of the document as a plurality of thumbnail images within the pane, each thumbnail image corresponding to a page of the document;
(c) displaying a selected page of the document as a main image within the same pane, wherein the main image overlaps with at least some of the thumbnail images, wherein the main image is displayed either as a transparent image or as a solid image,
wherein when the main image is displayed as the transparent image, the thumbnail images that overlap with the main image are displayed as visible thumbnail images through the transparent main image, and
wherein when the main image is displayed at the solid image, the thumbnail images that overlap with the main image are invisible in overlapped portions, and
(d) in response to a user's selection of one of the thumbnail images, displaying a new page of the document corresponding to the selected thumbnail image as the main image, wherein the newly displayed main image is displayed either as transparent image or as a solid image.

2. The method of claim 1, wherein the main image is located near a center of the pane and the thumbnail images occupy substantially the entire area of the pane.

3. The method of claim 1, wherein when the main image is displayed as the transparent image, the thumbnail images that completely overlap with the main image are selectable by the user, and wherein when the main image is displayed as the solid image, the thumbnail images that completely overlap with the main image are un-selectable by the user.

4. The method of claim 1, wherein when the main image is displayed as the transparent image, the main images is not editable, and wherein when the main image is displayed as the solid image, the main images is editable.

5. The method of claim 1, wherein step (c) comprises:
receiving a user mode selection input indicating a transparent display mode or a solid display mode; and
displaying the main image as the transparent image or the solid images based on the user mode selection input.

6. The method of claim 1, wherein step (b) comprises scrolling the thumbnail images within the pane.

7. The method of claim 1, wherein one of the plurality of thumbnail images corresponding to the selected page is highlighted.

8. A computer program product comprising a computer usable non-transitory medium having a computer readable program code embedded therein for controlling a computer system, the computer readable program code being configured to cause the computer system to execute a process for displaying a document on a display device of the computer system, the process comprising:
(a) displaying a window having at least one pane;
(b) displaying a plurality of pages of the document as a plurality of thumbnail images within the pane, each thumbnail image corresponding to a page of the document;
(c) displaying a selected page of the document as a main image within the same pane, wherein the main image overlaps with at least some of the thumbnail images, wherein the main image is displayed either as a transparent image or as a solid image,
wherein when the main image is displayed as the transparent image, the thumbnail images that overlap with the main image are displayed as visible thumbnail images through the transparent main image, and
wherein when the main image is displayed at the solid image, the thumbnail images that overlap with the main image are invisible in overlapped portions, and
(d) in response to a user's selection of one of the thumbnail images, displaying a new page of the document corresponding to the selected thumbnail image as the main image, wherein the newly displayed main image is displayed either as transparent image or as a solid image.

9. The computer program product of claim 8, wherein the main image is located near a center of the pane and the thumbnail images occupy substantially the entire area of the pane.

10. The computer program product of claim 8, wherein when the main image is displayed as the transparent image, the thumbnail images that completely overlap with the main image are selectable by the user, and wherein when the main image is displayed as the solid image, the thumbnail images that completely overlap with the main image are un-selectable by the user.

11. The computer program product of claim 8, wherein when the main image is displayed as the transparent image, the main images is not editable, and wherein when the main image is displayed as the solid image, the main images is editable.

12. The computer program product of claim 8, wherein step (c) comprises:
receiving a user mode selection input indicating a transparent display mode or a solid display mode; and
displaying the main image as the transparent image or the solid images based on the user mode selection input.

13. The computer program product of claim 8, wherein step (b) comprises scrolling the thumbnail images within the pane.

14. The computer program product of claim 8, wherein one of the plurality of thumbnail images corresponding to the selected page is highlighted.
